(19) United States
(12) Patent Application Publication
(10) Pub. No.: US 2014/0136307 A1
(43) Pub. Date: May 15, 2014

(54) USER MAP FOR EVENT OFFERS

(71) Applicant: STUBHUB, INC., San Francisco, CA (US)

(72) Inventors: Helen Jordan, San Francisco, CA (US); Nick Rudock, San Francisco, CA (US); Chris Boncimino, San Francisco, CA (US); Mike Ryan, San Francisco, CA (US)

(73) Assignee: STUBHUB, INC., San Francisco, CA (US)

(21) Appl. No.: 14/076,118

(22) Filed: Nov. 8, 2013

Related U.S. Application Data
(60) Provisional application No. 61/724,823, filed on Nov. 9, 2012.

(51) Int. Cl. G06Q 30/02

(52) U.S. Cl. CPC G06Q 30/0224
USPC 705/14.25; 705/14.1

(57) ABSTRACT

A user is presented with locations on a map of where the user can redeem offers at an event venue. The locations may show the closest locations to the user's seat, the locations with the shortest or fastest lines, locations that have a user's size or favorite color in stock for apparel, and/or locations that provide the user more specific information than just where an incentive can be used.

### CROSS REFERENCE TO RELATED APPLICATIONS

Pursuant to 35 U.S.C. §119(e), this application claims priority to the filing date of U.S. Provisional Patent Application No. 61/724,823, filed on Nov. 9, 2012, the disclosure of which is hereby incorporated by reference in its entirety.

### BACKGROUND

1. Field of the Invention

The present invention generally relates to event maps and in particular to event maps that show the user locations of offers at the venue.

2. Related Art

When a consumer is at an event, such as sports, music, theater, or other events at a venue, the consumer typically makes purchases while at the event. Purchases may include food, drink, and souvenirs, such as programs, apparel, memorabilia, and the like. Typically, the consumer walks around the event venue and stops in areas to browse and buy items. At times; the consumer may be given, at the event or beforehand, a coupon or other incentive to use at the event. The consumer then typically has to find a location to redeem or use the incentive.

It would be desirable to provide the consumer a more personalized and helpful experience for making purchases at an event venue.

### BRIEF DESCRIPTION OF THE FIGURES

FIG. 1 is a flowchart showing a process for showing a consumer locations where the consumer can redeem an offer according to one embodiment;

FIG. 2 is block diagram of a networked system suitable for implementing the process described herein according to an embodiment; and

FIG. 3 is a block diagram of a computer system suitable for implementing one or more components in FIG. 2 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to various embodiments, a user is presented with locations on a map of where the user can redeem offers at an event venue. The locations may show the closest locations to the user's seat, the locations with the shortest or fastest lines, locations that have a user's size or favorite color in stock for apparel, and/or locations that provide the user more specific information than just where an incentive can be used.

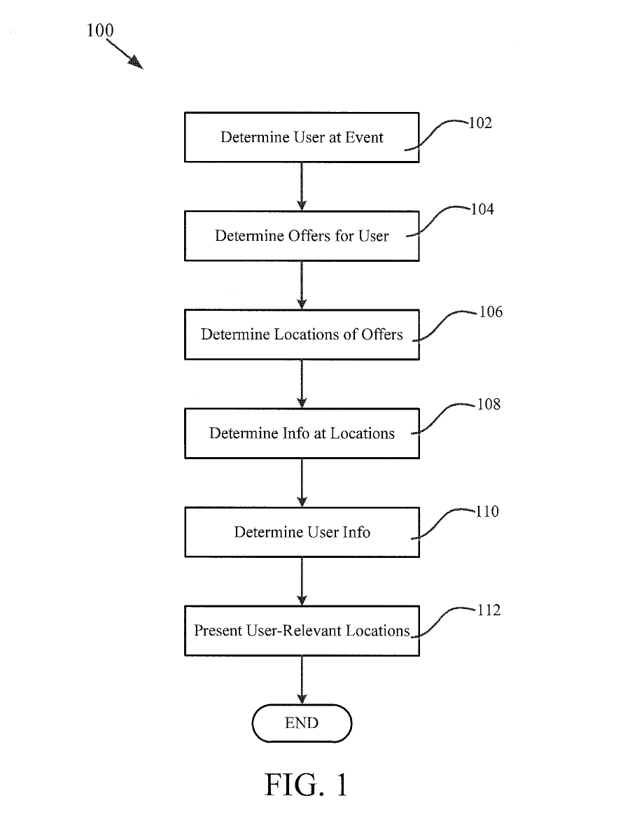

FIG. 1 is a flowchart showing a process 100 for displaying locations for a user to redeem or use incentives at an event venue, according to one embodiment. At step 102, a service provider, which can be a payment provider, a merchant, a ticket provider, such as StubHub, an event management entity, or other entity associated with a venue or event, determines a user will be or is at an event venue. The venue may be a stadium, hotel, arena, club, park, or any other building, housing, area that is holding or hosting an event. The event may be a concert, sporting event, music festival, conference, trade show or any other event where members of the public can attend and make purchases. The determination can be from the user purchasing a ticket for the event, indicating to the service provider that the user intends to be at the event, the user being detected at the event through a user device such as a smart phone, a user post on a social network, information from emails (such as scraping) indicating that the user has purchased a ticket or plans to be at the event, or any other suitable means.

Next, at step 104, offers available for the user at the event are determined. Offers may be for virtually anything that can be purchased at the event. Examples include incentives, such as discounts, free items, buy one get one free, etc., for food, drinks, clothing, programs, souvenirs, memorabilia, CDs, DVDs, accessories, and the like. Incentives can be restricted to specific items or specific types of items. The offers may be provided by the venue, vendors, or anyone else offering the items for sale to the user at the event. The offers may be general offers that can be used or provided to everyone attending the event. In other embodiments, the offers may be provided only to a certain number of event attendees, such as the first 200 who enter the venue. Offers may also be given to specific types or characteristics of event attendees, such as over 21 years of age, male, single females, over 65 years of age, etc.

In further examples, the offers may be specific to the individual user or attendee, such as based on the user purchase history, attendance history, etc. A user who frequently attends a Los Angeles Dodgers home game may receive a different offer than a user who seldom attends or is attending for the first time. Depending on the goal of the offer provider (reward the loyal fan or entice the new fan to attend more often), the offer may vary accordingly. In another example, a user who has a history of spending a lot of money at events or similar events may be provided a certain type of offer versus a user who rarely purchases items at an event. A further example is that a user who frequently purchases souvenirs may be provided offers for souvenirs, while a user who frequently purchases food may be provided with offers for food. User dependent offers may be even further refined. Using the previous example, a user who typically purchases shirts may be provided a different offer than a user who typically purchases hats. So, the type of purchase within a category may also be a factor in the offer provided to a user attending an event.

Once one or more offers are determined for a user, the service provider may determine, at step 106, where each offer can be used or redeemed. One offer, such as a 10% off coupon, may be redeemable at any location at the venue. Another offer, such as $5.00 off a hamburger and drink, may be redeemable at certain food locations that offer hamburgers. Another offer, such as 20% off selected shirts, may be redeemable at certain apparel locations. Another offer, such as 15% off binoculars and cushion rentals, may be redeemable at certain locations near entrances that offer both items. Thus, an offer or incentive may be redeemable or usable at all locations in the venue or only at certain locations, depending on the offer. Offers may also only be usable during certain times. For example, the offer may be used any time during the day of the event, only before the event starts or after the event ends during the day of the event, during intermissions only, etc.

Once the locations of offers are determined, information about one or more of the locations in obtained at step 108. The information may be data that would be relevant or useful to the user in determining when and whether to go to the location to use the offer. For example, for a location that the user can redeem a food or drink coupon, the service provider may determine the current wait time, number of lines, number of clerks, length of line(s), hours of operation, congestion or lack of congestion in the area of the location, etc. Generally, some of this information can be used to determine the “busyness” of a location, e.g., how busy the location currently is. This can be determined through information reported from the location, either through clerks, consumers, and/or electronic devices, such as sensors or Bluetooth Low Energy beacons.

For a location that the user can redeem a coupon for discount on a shirt or jacket, the service provider may determine the available inventory for a specific item or type of items that can be used with the coupon. For example, one location may have plenty of small sizes of a shirt, but only a few large and extra large sizes. In another location, that same shirt, which is subject of a coupon, may be abundantly available in all sizes. In another example, a location renting binoculars and/or seat cushions may only have a few left, while a different location may have plenty of both. The determinations may be made at the time or just before a user is to be presented with locations on a map, as will be discussed in more detail below. In addition to supply information, information similar to the food or drink offer may also be determined, such as wait time, number of clerks or cash registers currently open, hours of operation, length of lines, congestion in or around the store, booth, or sales area.

Next, at step 110, the service provider determines information about a particular user. This information may be available through the user's account with the service provider and/or other sources, including social networks and publicly available databases. Information from the user device at the event venue or from user input may be used to access the user's account to determine information. For example, a phone number of the user device may be used to locate a user account, or the user may access an app or service provider site and enter login information, such as a user identifier (email address, user name, phone number, etc.) and a password or PIN. The user's account may have information about the user's past purchases, past searches, interests, and profile information. For example, a user's profile may indicate the user's clothing size(s), favorite items, favorite item types, birthdays of user and user's friends/family, how often the user purchases certain items at certain types of events (such as t-shirts at concerts, cushions and binoculars at the Hollywood Bowl events, programs at sporting events), etc. The information may also indicate that the user typically purchases more items at an event during certain times of the month (such as paydays or near the user's birthday). Additional information may include how often the user makes purchases based on an offer or incentive.

The account information may include specific information about user purchases, such as clothing sizes for the user and others (for birthdays and other occasions), whether the user purchases drinks, food, souvenirs, or other types of products at certain types of events, and if so, what types or in what amounts, whether the user typically makes purchases during intermissions, before the event, after the event, or some other time period, whether the user typically makes purchases close to the seat location, at the venue entrance or exit, or at some other location, etc. Such information provides the service provider data that may enable more relevant offers to be provided to a specific user for a specific event that is more likely to result in the user making a purchase with the offer.

Using the various information obtained, the service provider can then present, at step 112, to the user, such as on the user device (e.g., smart phone), a map showing locations within the venue where the user can redeem offers or use incentives. In one embodiment, all locations where the user can redeem offers are shown on the map. The locations may simply be marked with an icon, such as a dot, or may include more information, such as a name, offer(s) that can be redeemed there, operating hours, etc.

In another embodiment, the map may display a subset of the locations, such as only user-relevant or user-specific locations for offer redemption. For example, only concession or food/drink locations that are open or having the shortest lines or wait times are shown. Other examples include only showing locations closest to the current user location or to the user seat location and/or only showing locations where an item is available, only showing locations where an item is available according to the user's preferences, such as size, color, etc. Thus, only locations where the user's size or size of other shirts/jackets purchased by the user is in stock are shown, which may save the user time from going to a location where a user-specific item is not available even though other items are available through the offer. In another example, if the day of the event is near a gift purchasing occasion for the user, such as a user's relative or Christmas, locations may be shown that have sizes of clothing the user has previously bought for others, specific item types, such as concert memorabilia, and the like.

Regardless of whether the map shows all locations available for offer redemption or only a subset, the map may also include details of each location, such as sizes available, quantities available, indication of busyness or congestion (such as wait times, length of lines, number of people, etc.). Thus, the user is better equipped to select a location to fit the user's needs in redeeming an offer or incentive at the venue.

As will be appreciated, the locations (either marked/displayed or information associated therewith) may change at different times of the event. For example, a certain location may have shorter lines at one time period, but longer lines at another time period. Also, a certain location may have plenty of user-preferred items at one time, but little or none at another time. Thus, the user map may change at different times throughout the event.

Offers may be shown on the map, such as associated with each location where the offer is redeemable. The user may select the location and retrieve the offer to be displayed on the user device. In other embodiments, the offer(s) may be presented on the user device prior to the map display. For example, the user may be sent electronic offers in various forms, such as a barcode, QR code, image, or other format that can be captured by a merchant and used by the user to make a purchase. In yet another example, one or more offers may be given or will be given to the user in physical form, such as by earlier mailing, upon entry of the event, at one or more locations within the event, etc. Regardless of how the user obtains the offer(s), either in physical form or electronic/digital format, the user will be able to see various locations in and around an event venue where the user can redeem the offer(s), along with additional information to help the user more efficiently utilize the offer(s).

Note that one or more steps described above may be omitted, combined, and/or performed in a different sequence as appropriate.

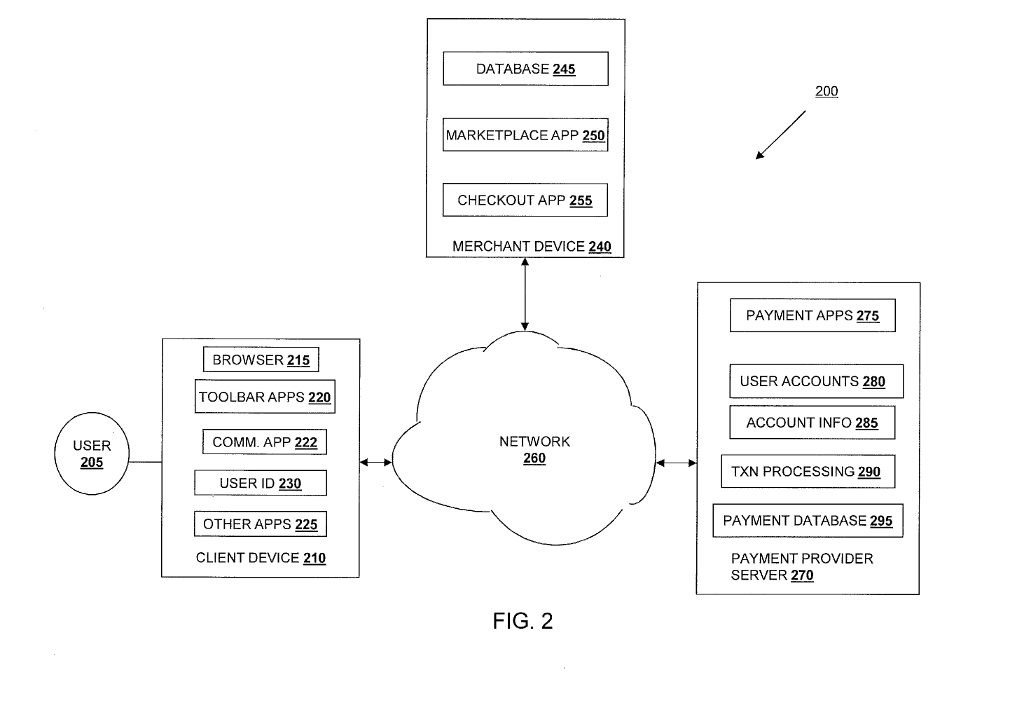

FIG. 2 is a block diagram of a networked system 200 configured to provide locations a user can redeem an offer at an event venue, such as described above, in accordance with an embodiment of the invention. System 200 includes a user device 210, a merchant server 240, and a payment provider server 270 in communication over a network 260. Payment provider server 270 may be maintained by a payment provider, such as PayPal, Inc. of San Jose, Calif. A user 205, such as a consumer, utilizes user device 210 to perform a transaction using payment provider server 270. Note that transaction, as used herein, refers to any suitable action performed using the user device, including payments, transfer of information, display of information, etc. Although only one merchant server is shown, a plurality of merchant servers may be utilized. For example, if the merchant server is operated by the venue and has all the information needed from the various locations within the venue, only the one server may be needed. However, if the various locations have different servers, multiple servers may be needed to communicate the desired information discussed above.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet, such as merchant site for purchasing. User device 210 may also include one or more toolbar applications 220 which may be used, for example, to provide client-side processing for performing desired tasks in response to operations selected by user 205, such as purchases from a selected merchant site or app. In one embodiment, toolbar application 220 may display a user interface in connection with browser application 215.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user view maps of an event venue as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider. A communications application 222, with associated interfaces, enables user device 210 to communicate within system 200.

Merchant server 240 may be maintained, for example, by a merchant or seller offering various products and/or services in exchange for payment to be received over network 260, including a venue operator. Merchant server 240 may be used for POS or online purchases and transactions, as well as for communicating information about locations within an event venue. Generally, merchant server 240 may be maintained by anyone or any entity that receives money, which includes charities as well as retailers and restaurants. Merchant server 240 includes a database 245 identifying available products and/or services (e.g., collectively referred to as items) which may be made available for viewing and purchase by user 205 with offers/incentives available to the user. Merchant server 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation from payment service provider server 270, as well as transmit transaction information to the payment provider and receive information from the payment provider (e.g., a transaction ID), including processing a shipment of purchased item(s) to the user.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant server 240 over network 260 to facilitate the purchase of goods or services, communicate/display information, and send payments by user 205 of user device 210 and as discussed above.

Payment provider server 270 also maintains a plurality of user accounts 280, each of which may include account information 285 associated with individual users. For example, account information 285 may include private financial information of users of devices such as account numbers, passwords, device identifiers, user names, phone numbers, credit card information, bank information, or other financial information which may be used to facilitate online transactions by user 205. Account information may also include user purchase history, including details of items purchased, such as sizes, as discussed herein. Advantageously, payment application 275 may be configured to interact with merchant server 240 on behalf of user 205 during a transaction with checkout application 255 to track and manage purchases made by users and to show user-specific locations where a user can redeem an offer.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order, such for a purchase of an item at a venue location. Payment application 275 may be further configured to determine the existence of and to manage accounts for user 205, as well as create new accounts if necessary, such as the setup, management, and use of payment accounts.

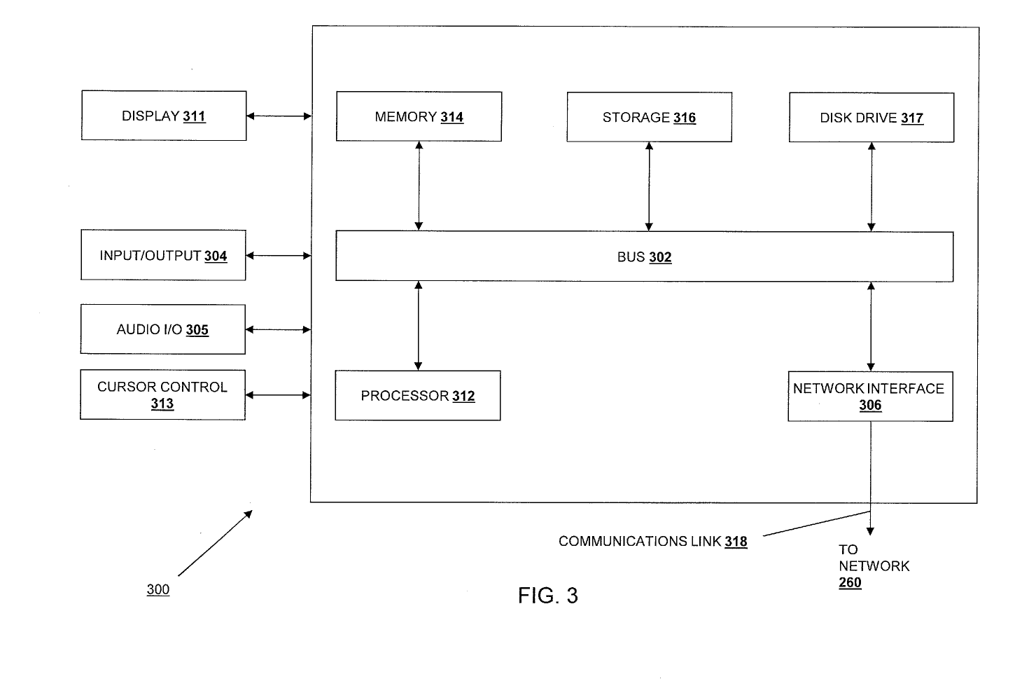

FIG. 3 is a block diagram of a computer system 300 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 (capable of showing an event venue map) and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 260. In one embodiment, the transmission is wireless, although other transmission mediums and methods may also be suitable. A location determining component 320, such as a GPS system or chip or other devices/systems described herein, communicates with bus 302 to communicate location data that enables a service provider to determine the location of computer system 300. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing account information for a plurality of users, wherein the account information comprises information about previous purchases by a user; and
one or more processors operable to:
determine offers available to a user at a venue for an event;
determine locations in or around the venue where the offers can be redeemed by the user before, during, or after the event; and
communicate data to a user device to enable a map to be displayed on the user device, wherein the map shows the locations in or around the venue where the offers can be redeemed by the user.

2. The system of claim 1, wherein the one or more processors is further operable to determine information about the locations.

3. The system of claim 1, wherein the information comprises an indication of busyness at a location.

4. The system of claim 1, wherein the information comprises an indication of availability of one or more items at a location.

5. The system of claim 4, wherein the availability is for items preferred by the user based on previous purchases made by the user or by a user profile.

6. The system of claim 3, wherein the indication of busyness comprises a wait time or a line length.

7. The system of claim 1, wherein the locations shown on the map include information about the location.

8. The system of claim 7, wherein the information about the location comprises an indication of busyness and/or an indication of available items associated with the offers.

9. The system of claim 1, wherein which locations are shown are based on purchase history of the user, a profile of the user, availability of items, and/or an indication of busyness.

10. A method for performing a transaction using a user device, comprising:
determining offers available to a user at a venue for an event;
determining locations in or around the venue where the offers can be redeemed by the user before, during, or after the event; and
communicating, electronically by a hardware processor, data to a user device to enable a map to be displayed on the user device, wherein the map shows the locations in or around the venue where the offers can be redeemed by the user.

11. The method of claim 10, wherein the information comprises an indication of busyness at a location.

12. The method of claim 10, wherein the information comprises an indication of availability of one or more items at a location.

13. The method of claim 12, wherein the availability is for items preferred by the user based on previous purchases made by the user or by a user profile.

14. The method of claim 11, wherein the indication of busyness comprises a wait time or a line length.

15. A non-transitory machine-readable medium comprising a plurality of machine-readable instructions which when executed by one or more processors of a server are adapted to cause the server to perform a method comprising:
determining offers available to a user at a venue for an event;
determining locations in or around the venue where the offers can be redeemed by the user before, during, or after the event; and
communicating data to a user device to enable a map to be displayed on the user device, wherein the map shows the locations in or around the venue where the offers can be redeemed by the user.

16. The non-transitory machine-readable medium of claim 15, wherein the information comprises an indication of busyness at a location.

17. The non-transitory machine-readable medium of claim 15, wherein the information comprises an indication of availability of one or more items at a location.

18. The met non-transitory machine-readable medium of claim 17, wherein the availability is for items preferred by the user based on previous purchases made by the user or by a user profile.

19. The non-transitory machine-readable medium of claim 16, wherein the indication of busyness comprises a wait time or a line length.
